(19) United States
(12) Patent Application Publication
(10) Pub. No.: US 2015/0023601 A1
(43) Pub. Date: Jan. 22, 2015

(54) ROBUST ANALYSIS FOR DEFORMABLE OBJECT CLASSIFICATION AND RECOGNITION BY IMAGE SENSORS

(71) Applicant: OmniVision Technologies, Inc., Santa Clara, CA (US)

(72) Inventor: Ming-Kai Hsu, Fremont, CA (US)

(21) Appl. No.: 13/946,299

(22) Filed: Jul. 19, 2013

(51) Int. Cl. G06K 9/62; G06K 9/46

(52) U.S. Cl. CPC G06K 9/6202; G06K 9/4661
USPC 382/190; 382/218

(57) ABSTRACT

A method and a system of identifying deformable objects in digital images using processing circuitry are disclosed. The method includes partitioning, using the processing circuitry, a composite image into M composite blocks. An input image is partitioned into M input blocks. Each input block is paired with a corresponding composite block. Image properties of each composite block and each input block are analyzed. The image properties of each input block are compared with its corresponding composite block. A structural similarity value for each pair of input and composite blocks is generated in response to comparing the image properties. An aggregate structural similarity value is determined based on the structural similarity values. A deformable object category of the input image is identified based on the aggregate structural similarity value.

### TECHNICAL FIELD

This disclosure relates generally to image analysis. In particular but not exclusively, it relates to using a regression algorithm to classify and recognize deformable objects, such as eyes and mouths, in images that are being detected by an image sensor.

### BACKGROUND INFORMATION

Innovation in regression technology has allowed for advancement in object detection, tracking, classification and recognition. A partial list of applications of regression technology includes face recognition on mobile devices and ATM machines, video based face recognition, eye blink detection, smile detection, barcode recognition, gesture detection and recognition, and automatic warning systems on vehicles.

Regression is a statistical tool that can be used for modeling and analyzing variables, including the investigation of the relationship between variables, the estimation and/or prediction for dependent variables, and the partition and/or classification for dependent variables. The general mathematical form of regression can be denoted as y=(X, β), where X is a set of independent variables belonging to space R^{n*p}, y is a dependent variable belonging to space Rⁿ, and β is a set of unknown variables belonging to space R^{p}. Regression is traditionally based on residual analysis. Residual is the difference between the actual response y and the predicted response ŷ that is projected onto the space spanned by X. Regression analysis has been used as a tool for image processing.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a column of input images, a column of composite images generated by a composition method A, and a column of composite images generated by a composition method B.

FIG. 2 illustrates a process of identifying deformable objects in digital images, in accordance with an embodiment of the disclosure.

FIG. 3 is an example block diagram that illustrates an example implementation of some of the process blocks in FIG. 2, in accordance with an embodiment of this disclosure.

FIG. 4 is a functional block diagram illustrating an imaging system, in accordance with an embodiment of the disclosure.

### DETAILED DESCRIPTION

Embodiments of a system and a method for classifying deformable objects in digital images are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Traditionally, the art of deformable object (e.g., eyes) recognition uses regression analysis based on a residual approach. In a residual approach, an input image is obtained. Then, a certain composition method is applied to an existing database containing many images of objects of the same type (i.e., eyes) in order to construct a composite image, which is then compared with the input image by analyzing the residual. If the residual is small enough, then the input image is deemed to have matched the composite image. However, residual-based regression approach can be problematic.

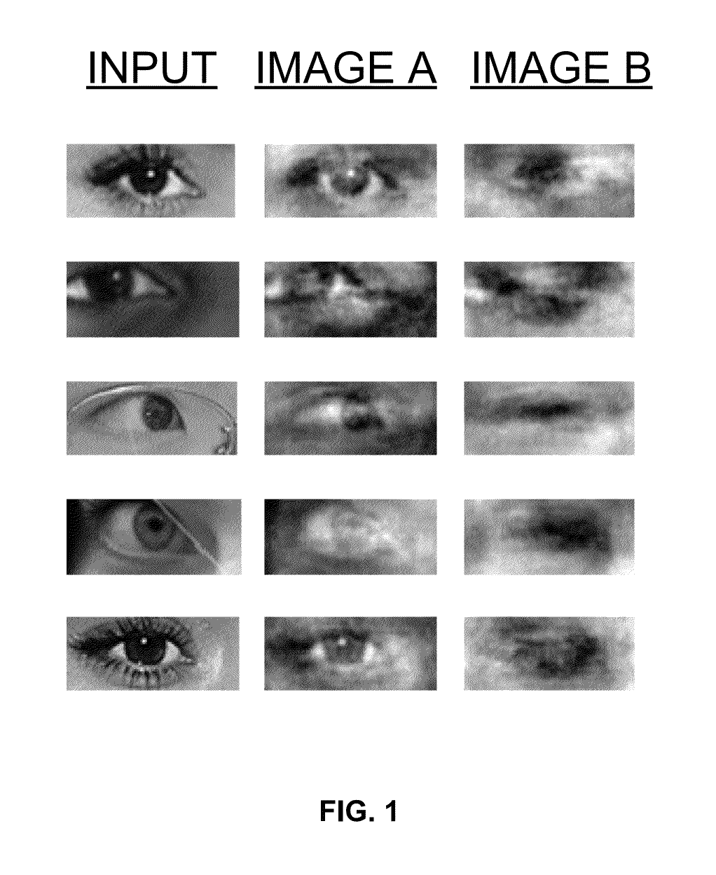

FIG. 1 illustrates a column of input images, a column of composite images generated by a composition method A, and a column of composite images generated by a composition method B. In FIG. 1, the middle column (under the heading “Image A”) includes images generated from an existing database of eyes, using a composition method A. The right column (under the heading “Image B”) includes images generated from an existing database of eyes, using a composition method B. According to a residual-based regression analysis, the images in the far right column (Image B column) are deemed a better fit to the input images in the far left column than the images in the middle column (Image A column). However, a person performing a visual selection on the Image A and Image B columns would select the images in column A as being a better fit to the input images in the far left column rather than the images in column B. The reason why residual-based regression analysis sometimes produces an unreasonable result is because it looks at the sum of pixel differences squared to see if it is the least sum squared value, while completely ignoring the geometric structure of the images. Consequently, it is clear that a residual-based regression approach to image analysis can be improved upon.

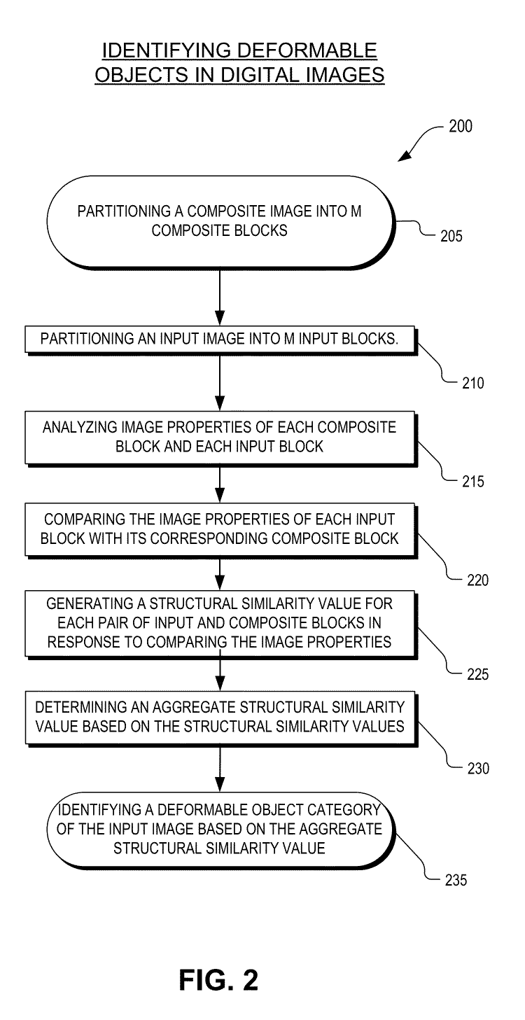

FIG. 2 illustrates a process 200 of identifying deformable objects in digital images, in accordance with an embodiment of this disclosure. The order in which some or all of the process blocks appear in process 200 should not be deemed limiting. Rather, one of ordinary skill in the art having the benefit of the present disclosure will understand that some of the process blocks may be executed in a variety of orders not illustrated, or even in parallel.

Before describing process block 205, generating a composite image to be used in process block 205 will be described. The composite image that is partitioned in process block 205 may be generated from a database of sample images of deformable objects (e.g. eyes, mouth). The composite image may be generated by finding a matrix that minimizes error.

Suppose the database of deformable objects is of eyes and includes n number of sample eyes, and each sample eye is a column vector of m components, i.e., xεRⁿ. Also suppose an input image is represented by a column vector y belonging to space R^{m}. Matrix A is a collection of n sample column vectors, each of which have m components. Therefore, matrix A has a dimension of m by n. The goal is to find a solution x, such that Ax=y, where xεRⁿ. The composite eye is produced in order to match the input eye.

In some solutions, a deformable objects database, that is quite large (such that n>m) is used to generated the composite image. These systems are regarded as “over-complete.” However, it has been observed that a deformable objects database that is not large (such that n<m) may be used to generate a satisfactory composite image. Such a system where the sample size n is less than m, which is the dimension of the input deformable object image vector, is called “over-determined.” To generate a satisfactory composite image using an “over-determined” system, L1 regularization is used, as described below.

L1 regularization includes finding a column vector x such that x satisfies the minimum of the following expression, which is a sum of the square of a second-norm and a linear representation of a first-norm:

∥y−Ax∥₂²+λ∥x∥₁ (Equation 1)

The first-norm is defined in Equation 2:

$${‖ x ‖}_{1} = {\sum }_{i ∈ N} \vert {x}_{i} \vert$$

and the second-norm is defined in Equation 3:

$${‖ x ‖}_{2} = \sqrt{{\sum }_{i ∈ N} {\vert {x}_{i} \vert}^{2}}$$

In other words, x needs to satisfy:

minₓ∥y−Ax∥₂²+λ∥x∥₁ (Equation 4)

The above described L1 regularization to find column vector x will work. L1 regularization may be used to produce a composite image from a relatively small database of deformable object (e.g. eyes) images, where n (which is the number of sample deformable objects in this database) is smaller than m (which is the length of the column vector that is used to describe an eye in the input image).

After a composite deformable object (e.g. an eye) image is constructed using L1 regularization, the composite deformable object image must be analyzed to see how similar it is to the input deformable object (e.g. eye) image. As discussed above in association with FIG. 1, a residual analysis does not always yield satisfactory results.

In the human visual system, object classification and recognition are more sensibly determined by similarity, i.e., how similar one object appears with regard to another object. More specifically, human eyes perceive that images are composed of different color intensities. The permutations of color or intensities create structures (geometrical information) and textures (textual information). In general, an image can be regarded as composed of structural parts for each object in the image and textural parts for fine details of each object.

Embodiments of this disclosure describe a regression approach that is based on similarity. The following paragraphs disclose embodiments of the decision rule in regression for 2D deformable objects classification and recognition that consider similarity of image structures and textures.

Turning to process block 205, a composite image is partitioned into M number of composite blocks. As discussed above, the composite image may be a digital image of a deformable object that was generated using L1 regularization. For the purposes of the disclosure, the composite blocks (which may also be known as “reference blocks”) will be represented by “x.” In one embodiment, the composite block is a digital image of an eye for the reference of the digital input image, which may also be of an eye.

In process block 210, an input image is also partitioned into M number of input blocks. The input image may be a digital image of a deformable object. The input image may have been captured by a digital image sensor. For the purposes of the disclosure, the input blocks will be represented by “y.” Each input block y is paired with a corresponding composite block x. In other words, each input block y has one-to-one correspondence with its corresponding composite block x.

We refer to the composite blocks and input blocks as “blocks” because each image is partitioned into a number of blocks, and then each block is evaluated for similarity. The composite image (of a deformable object) can be thought of as a collection of composite blocks and the input image (also of a deformable object) can be thought of as a collection of input blocks.

In process block 215, image properties of each composite block and each input block are analyzed. In one embodiment, the image properties include luminance, contrast, and structure. In this case, analysis is performed on each composite block and input block to determine a luminance measurement, a contrast measurement, and a structural measurement of each block. Of the image properties, luminance and contrast are easily ascertained from the signal (in the respective blocks) itself because they are explicit components of the signal, as is known in the art. However, the structural element is implicit and will need to be extracted from the signal, as will be disclosed below.

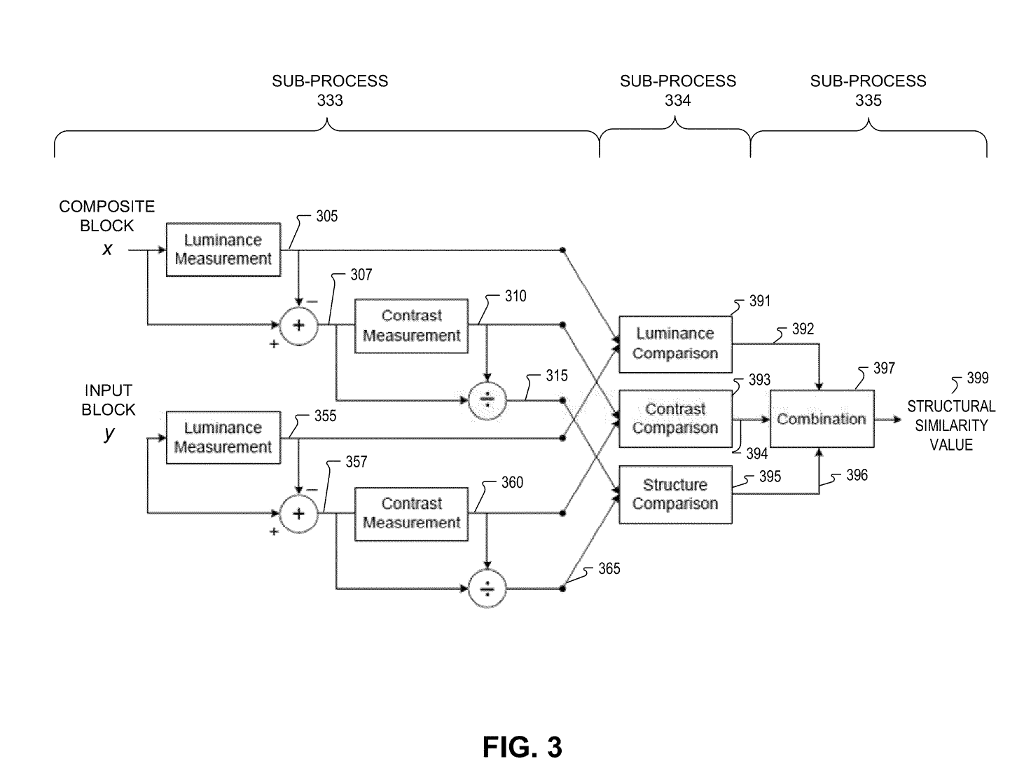

FIG. 3 is an example block diagram that illustrates an example implementation of some of the process blocks in process 200, in accordance with an embodiment of this disclosure. For example, analyzing the image properties in process block 215 may include sub-process 333, in FIG. 3. Sub-process 333 includes extracting a luminance measurement 305 from composite block x and extracting a luminance measurement 355 from the input block y that corresponds to composite block x. Composite block x and input block y may each be represented as a column vector as they are fed into the respective luminance measurements of sub-process 333. As sub-process 333 shows, a first signal stream 307 may be generated by subtracting luminance measurement 305 from composite block x and a second signal stream 357 may be generated by subtracting luminance measurement 355 from the input block y that corresponds to composite block x. A contrast measurement 310 may be extracted from first signal stream 307 and contrast measurement 360 may be extracted from the second signal stream 357. To generate structural measurement 315, first signal stream 307 is divided by contrast measurement 310. Similarly, structural measurement 365 is generated by dividing second signal stream 357 with contrast measurement 360.

In process block 220, the image properties of each input block are compared with its corresponding composite block. In one embodiment, sub-process 334 in FIG. 3 may be included in process block 220. Sub-process 334 shows the image properties of luminance, contrast, and structure being compared in luminance comparison block 391, contrast comparison block 393, and structure comparison block 395.

Luminance comparison block 391 generates a luminance comparison value 392 by performing a luminance comparison l(x,y) that compares luminance measurement 355 (the input luminance value) with luminance measurement 305 (the composite luminance value). Luminance comparison l(x,y) can be mathematically defined as:

$$l ( x , y ) = \frac{2 {μ}_{x} {μ}_{y} + {C}_{1}}{{μ}_{x}^{2} + {μ}_{y}^{2} + {C}_{1}} \qquad ( Equation 5 )$$

where x and y are composite and input blocks, respectfully, and μ is the mean intensity of each respective block. C₁ is a constant. μₓ is mathematically defined in Equation 6.1:

$${μ}_{x} = \frac{1}{N} {\sum }_{i = 1}^{N} {x}_{i}$$

where x is the composite block, N is the number of pixels in that block, and μₓ is the mean intensity of composite block x. μ_{y} is mathematically defined in Equation 6.2:

$${μ}_{y} = \frac{1}{N} {\sum }_{i = 1}^{N} {y}_{i}$$

where y is the input block, N is the number of pixels in that block, and μ_{y} is the mean intensity of input block y.

Contrast comparison block 393 generates a contrast comparison value 394 by performing a contrast comparison c(x,y) that compares contrast measurement 360 (the input contrast value) with contrast measurement 310 (the composite contrast value).

Contrast comparison c(x,y) can be mathematically defined as:

$$c ( x , y ) = \frac{2 {σ}_{x} {σ}_{y} + {C}_{2}}{{σ}_{x}^{2} + {σ}_{y}^{2} + {C}_{2}} \qquad ( Equation 7 )$$

where x and y are composite and input blocks, respectfully, and the standard deviation σₓ is used as an approximation of contrast in x. C₂ is a constant. σₓ is mathematically defined as in Equation 8.1:

$${σ}_{x} = {( \frac{1}{N - 1} {\sum }_{i = 1}^{N} {( {x}_{i} - {μ}_{x} )}^{2} )}^{1 / 2}$$

where x is the composite block and N is the number of pixels in that block. σ_{y} is mathematically defined as in Equation 8.2:

$${σ}_{y} = {( \frac{1}{N - 1} {\sum }_{i = 1}^{N} {( {y}_{i} - {μ}_{y} )}^{2} )}^{1 / 2}$$

where y is the input block and N is the number of pixels in that block.

Structure comparison block 395 generates a structural comparison value 396 by performing a structural comparison c(x,y) that compares structural measurement 365 (the input structural value) with structural measurement 315 (the composite structural value). Structural comparison c(x,y) can be mathematically defined as:

$$s ( x , y ) = \frac{{σ}_{xy} + {C}_{3}}{{σ}_{x} {σ}_{y} + {C}_{3}} \qquad ( Equation 9 )$$

where x and y are composite and input blocks, respectfully, and σₓ is defined above. C₃ is a constant. In the present disclosure, C₂=2C₃. Equation 10 mathematically defines σ_{xy} as:

$${σ}_{xy} = \frac{1}{N - 1} {\sum }_{i = 1}^{N} ( {x}_{i} - {μ}_{p} ) ( {y}_{i} - {μ}_{p} )$$

when p is the block to be operated on (composite block or input block), μₚ is the mean intensity of p, and N is the number of pixels in in p.

In process block 225, a structural similarity value is generated for each corresponding pair of composite blocks x and input blocks y so that each pair has a structural similarity value assigned to it. The structural similarity value is generated in response to the comparing of image properties in process block 220. In one embodiment, sub-process 335 in FIG. 3 may be included in process block 225. Sub-process 335 shows a structural similarity value 399 generated by combining luminance comparison value 392, contrast comparison value 394, and structural comparison value 396.

When sub-processes 333, 334, and 335 of FIG. 3 are all included in an embodiment as shown in FIG. 3, it is referred to as Structural Similarity (“SSIM”). SSIM is mathematically defined as follows:

SSIM(x,y)=[l(x, y)]^{α}·[c(x,y)]^{β}·[s(x,y)]^{γ} (Equation 11)

The relative importance of luminance, contrast, and structure can be adjusted with exponential parameters α, β, and γ, respectively. In the present disclosure, the three exponential parameters are all equal to one.

In process block 230, an aggregate structural similarity value based on the structural similarity values of each pair of corresponding composite blocks x and input blocks y is determined. In one embodiment, the structural similarity values are averaged. This embodiment may be referred to as Mean Structural Similarity (“MSSIM”), which is mathematically defined as:

$$M S S I M = \frac{1}{M} {\sum }_{j = 1}^{M} S S I M ( {x}_{j} , {y}_{j} ) \qquad ( Equation 12 )$$

where M is the number of blocks that the composite image and the input image were partitioned into.

In process block 235, a deformable object category (e.g. eyes) of the input image is identified based on the aggregate structural similarity value. Therefore, the composite images generated from deformable object databases can be measured to match the input image and the measurements determine when the input image is associated with a deformable object category.

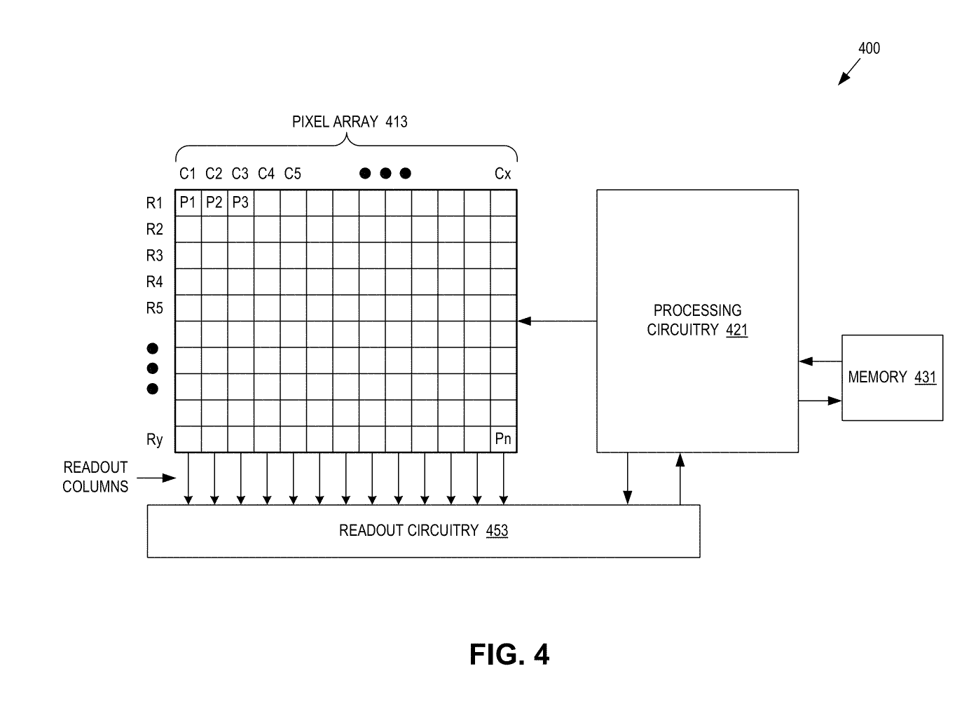

FIG. 4 is a functional block diagram illustrating an imaging system 400, in accordance with an embodiment of the disclosure. The illustrated embodiment of imaging system 400 includes pixel array 413, readout circuitry 453, processing circuitry 421, and memory 431. Pixel array 413 is a two-dimensional (“2D”) array of imaging sensors or pixels (e.g., pixels P1, P2 . . . , Pn). In one embodiment, each pixel is a complementary metal-oxide-semiconductor (“CMOS”) imaging pixel. As illustrated, each pixel is arranged into a row (e.g., rows R1 to Ry) and a column (e.g., column C1 to Cx) to acquire image data of a person, place, or object, which can then be used to render a 2D image of the person, place, or object.

After each pixel has acquired its image data or image charge, the image data is read out by readout circuitry 453 and transferred to processing circuitry 421. Processing circuitry 421 is coupled to pixel array 413 to control operational characteristic of pixel array 413. Processing circuitry 421 may include a digital signal processor (“DSP”). In one embodiment, processing circuitry may include a microprocessor and/or a field programmable gate array (“FPGA”). Processing circuitry 421 may generate a shutter signal for controlling image acquisition and processing circuitry 421 may control the readout of readout circuitry 453. Readout circuitry 453 may include amplification circuitry, analog-to-digital (“ADC”) conversion circuitry, or otherwise. Processing circuitry 421 may store the image data from captured images or even manipulate the image data by applying post image effects (e.g., crop, rotate, remove red eye, adjust brightness, adjust contrast, or otherwise).

The methods and processes in this disclosure may be used in imaging system 400. More specifically the processes and methods may be stored as instruction for processing circuitry 421 to perform. The instructions may be stored within a memory (not illustrated) stored within processing circuitry 421 or the instructions may be stored within memory 431. Processing circuitry 421 may cause pixel array 413 and readout circuitry 453 to capture and read out an image. Processing circuitry 421 may then use all or part of that image as the input image of process block 210. Processing circuitry 421 may access instructions stored in memory to execute process 200. Processing circuitry 421 may access an internal memory (not illustrated) or access memory 431 to read databases of deformable object images to generate the composite image of process block 205. When processing circuit 421 completes process 200, it may have identified a deformable object category of the input image. Processing circuitry 421 may then perform additional operations (e.g. capture more images) in response to identifying the deformable object category.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of identifying deformable objects in digital images using a processing unit, the method comprising:
partitioning, using the processing unit, a composite image into M composite blocks;
partitioning an input image into M input blocks, wherein each input block is paired with a corresponding composite block;
analyzing image properties of each composite block and each input block;
comparing the image properties of each input block with its corresponding composite block;
generating a structural similarity value for each pair of input and composite blocks in response to comparing the image properties;
determining an aggregate structural similarity value based on the structural similarity values; and
identifying a deformable object category of the input image based on the aggregate structural similarity value.

2. The method of claim 1, wherein analyzing the image properties includes:
extracting a luminance measurement from a given block;
generating a first signal stream by subtracting the luminance measurement from the given block;
extracting a contrast measurement from the first signal stream; and
generating a structural measurement by dividing the first signal stream by the contrast measurement.

3. The method of claim 1, wherein comparing the image properties of each input block with it corresponding composite block includes:
generating a luminance comparison value by comparing an input luminance value from a given input block with a composite luminance value from the corresponding composite block of the given input block;
generating a contrast comparison value by comparing an input contrast value from the given input block with a composite contrast value from the corresponding composite block of the given input block; and
generating a structural comparison value by comparing an input structural value from the given input block with a composite structural value from the corresponding composite block of the given input block.

4. The method of claim 3, wherein generating a structural similarity value includes combining the luminance comparison value, the contrast comparison value, and the structural comparison value.

5. The method of claim 1, wherein the composite image is constructed using L1 regularization of an over-determined image database set.

6. The method of claim 1, wherein each input block has a one-to-one correspondence with its corresponding composite block.

7. The method of claim 1, wherein the input image is at least a portion of a captured image that was captured by a digital image sensor.

8. The method of claim 1, wherein the deformable object category is an eye category.

9. The method of claim 1, wherein the deformable object category is a mouth category.

10. A non-transitory machine-accessible storage medium that provides instructions that, when executed by an image processor, will cause the image processor to preform operation comprising:
partitioning, using the image processor, a composite image into M composite blocks;
partitioning an input image into M input blocks, wherein each input block is paired with a corresponding composite block;
analyzing image properties of each composite block and each input block;
comparing the image properties of each input block with its corresponding composite block;
generating a structural similarity value for each pair of input and composite blocks in response to comparing the image properties;
determining an aggregate structural similarity value based on the structural similarity values; and
identifying a deformable object category of the input image based on the aggregate structural similarity value.

11. The non-transitory machine-accessible storage medium of claim 10, wherein analyzing the image properties includes:
extracting a luminance measurement from a given block;
generating a first signal stream by subtracting the luminance measurement from the given block;
extracting a contrast measurement from the first signal stream; and
generating a structural measurement by dividing the first signal stream by the contrast measurement.

12. The non-transitory machine-accessible storage medium of claim 10, wherein comparing the image properties of each input block with it corresponding composite block includes:
generating a luminance comparison value by comparing an input luminance value from a given input block with a composite luminance value from the corresponding composite block of the given input block;
generating a contrast comparison value by comparing an input contrast value from the given input block with a composite contrast value from the corresponding composite block of the given input block; and
generating a structural comparison value by comparing an input structural value from the given input block with a composite structural value from the corresponding composite block of the given input block.

13. The non-transitory machine-accessible storage medium of claim 12, wherein generating a structural similarity value includes combining the luminance comparison value, the contrast comparison value, and the structural comparison value.

14. The non-transitory machine-accessible storage medium of claim 10, wherein the composite image is constructed using L1 regularization of an over-determined image database set.

15. An imaging system comprising:
a pixel array having pixels arranged in rows and columns;
processing circuitry coupled to the pixel array to control image capturing; and
a non-transitory machine-accessible storage medium that provides instruction that, when executed by the imaging system, will cause the imaging system to perform operation comprising:
partitioning a composite image into M composite blocks;
partitioning an input image that was captured by the pixel array into M input blocks, wherein each input block is paired with a corresponding composite block;
analyzing image properties of each composite block and each input block;
comparing the image properties of each input block with its corresponding composite block;
generating a structural similarity value for each pair of input and composite blocks in response to comparing the image properties;
determining an aggregate structural similarity value based on the structural similarity values; and
identifying a deformable object category of the input image based on the aggregate structural similarity value.

16. The imaging system of claim 15, wherein analyzing the image properties includes:
extracting a luminance measurement from a given block;
generating a first signal stream by subtracting the luminance measurement from the given block;
extracting a contrast measurement from the first signal stream; and
generating a structural measurement by dividing the first signal stream by the contrast measurement.

17. The imaging system of claim 15, wherein comparing the image properties of each input block with it corresponding composite block includes:
generating a luminance comparison value by comparing an input luminance value from a given input block with a composite luminance value from the corresponding composite block of the given input block;
generating a contrast comparison value by comparing an input contrast value from the given input block with a composite contrast value from the corresponding composite block of the given input block; and
generating a structural comparison value by comparing an input structural value from the given input block with a composite structural value from the corresponding composite block of the given input block.

18. The imaging system of claim 17, wherein generating a structural similarity value includes combining the luminance comparison value, the contrast comparison value, and the structural comparison value.

19. The imaging system of claim 15, wherein the composite image is constructed using L1 regularization of an over-determined image database set.

20. The imaging system of claim 15 further comprising a memory coupled to the processing circuitry, wherein the memory includes a deformable object image database for constructing the composite image.
